(19) United States
(12) Patent Application Publication
(10) Pub. No.: US 2021/0396241 A1
(43) Pub. Date: Dec. 23, 2021

(54) ROLLING BEARING HAVING A SEALING ASSEMBLY AND WATER PUMP HAVING SAME

(71) Applicant: NIDEC GPM GmbH, Auengrund OT Merbelsrod (DE)

(72) Inventors: Paul Michael Ludwig, Erfurt (DE); Franz Pawellek, Lautertal (DE)

(21) Appl. No.: 17/279,131

(22) PCT Filed: Sep. 16, 2019
(86) PCT No.: PCT/EP2019/074683

§ 371 Date: Mar. 24, 2021

(30) Foreign Application Priority Data
Sep. 27, 2018 (DE) 10 2018 123 908.4

(51) Int. Cl. F04D 29/049; F04D 29/06; F16C 33/66; F16C 19/18; F16C 33/58; F16C 33/78; F16C 33/80; F16N 7/22

(52) U.S. Cl. CPC F04D 29/049; F04D 29/061; F16C 33/6648; F16C 19/18; F16C 2360/44; F16C 33/784; F16C 33/80; F16N 7/22; F16C 2208/32; F16C 33/581

(57) ABSTRACT

A rolling bearing having a sealing arrangement, preferably as a compact bearing and seal for water pumps, is proposed having two axially adjacent rolling-element rows between an outer ring and a shaft bearing section, and a wet-side shaft seal and a dry-side shaft seal. A lubricant reservoir with a substrate that is porous in at least some sections is arranged circumferentially in a radial contact to the shaft section and the outer ring; wherein the lubricant reservoir in pores of the substrate, includes a lubricant insoluble in water, and a volume of the lubricant reservoir and a volume of a lubricant filling with the lubricant take up a total volume of spaces between the wet-side shaft seal and the dry-side shaft seal.

The present invention relates to a rolling bearing having a sealing arrangement for water pumps, and to a water pump for a coolant circuit in a vehicle which comprises the rolling bearing having the sealing arrangement.

For water pumps which are used in vehicles there is a common pump design in which the pump shaft is mounted in the pump housing by means of a single compact bearing having two rolling-element rows which absorbs both radial and also axial forces of the shaft. This arrangement permits a compact design in relation to the shaft length and provides advantages in terms of the number of housing fits and bearing clearances, shaft alignment and production and assembly.

In general, rolling-element bearings are sensitive to the ingress of moisture because the materials used, in particular suitable steels of the rolling elements and raceways, are not sufficiently corrosion-resistant for use in moisture. Small leakages always occur at bearing seals. The occurrence of moisture leads, by reason of corrosion, to the reduction in the surface quality of the rolling elements and raceways, which leads to greater friction of the bearing and corresponding heat development and ultimately to damage to the bearing and results in the water pump becoming defective. In addition, water pumps are increasingly electrically driven, wherein an electric motor of the dry-runner type is frequently used on the drive-side. Just like the compact bearing, the electric motor must also be protected against the ingress of coolant leakage from the flow to be conveyed from the water pump.

A shaft bearing or its seal often constitutes the limiting factor for the service life of a pump because it is subjected, per se, to frictional wear and embrittlement as a result of pressure and temperature fluctuations. Therefore, in terms of the operating reliability of the vehicle great importance is placed on a durable sealing arrangement of a water pump, i.e. a liquid seal between the flow to be conveyed in a pump chamber and the compact bearing and the downstream drive-side region of the pump housing.

Conventionally, rolling bearings are sealed between a shaft or an inner ring and an outer ring by radially sealing seals in the form of sealing discs or sealing rings in the region of the rolling elements. The smaller the radial dimensions of a rolling bearing, the more difficult it becomes to use an effective radial seal, such as a standardised oil seal or a radial shaft sealing ring (DIN 3760) or the like, owing to the reduced installation space in the bearing.

Furthermore, seals of shafts with respect to static components of a water pump by shaft sealing rings having a lip seal, sliding ring seals or the like are known from the prior art. The service life of such radial shaft seals depends greatly upon the lubricating conditions at the sealing lip. Dry-running sealing lips which are lubricated merely by a coolant leakage have a shorter service life than sealing lips in the environment of a lubricating oil-carrying system by reason of the coefficient of friction of the lubricating film and a phenomenon explained hereinafter. For instance, the formation of deposits under the dynamic sealing surface of the sealing lip which adversely affects the sealing function is observed. This is caused by leakage drops of a coolant which vaporise upon passing through the sealing point and leave behind crystalline components of the coolant which form a deposit on the shaft or the inner ring.

Furthermore, concepts for sealing pump shafts are known which provide discharging of an unavoidable leakage at a shaft seal. A corresponding pump design generally comprises a leakage chamber which is arranged in a pump housing beneath the pump shaft and discharges an accumulated leakage via a run-off bore or a moisture-permeable membrane.

Patent application DE 10 2018 105 088.7, which was not yet published on the filing date of this patent application and is by the same applicant, relates to such a pump design and a sealing arrangement for a pump having a rolling bearing and a dry-running electric motor. A leakage chamber is formed in the housing in order to collect a leakage downstream of a shaft seal to a pump chamber and upstream of a shaft seal to the rolling bearing and thus to protect the rolling bearing, the electric motor and control electronics from being damaged by the ingress of wetness. In operation, the accumulated leakage is heated and evaporates to the atmosphere through a bore. Such a design disadvantageously requires at least one additional installation space for the leakage chamber in the pump housing.

Rolling bearings not of the type in question have become known from other technical applications, in which a so-called “solid oil” is used to lubricate rolling elements. “Solid oil” is produced in principle by an oversaturated oil impregnation of a porosity acting in a capillary manner in a surface or a material of an element. Rolling bearings are known in which such a structure is provided in the region of a rolling element guide or a bearing cage in order to wet a contacted surface of the rolling elements with oil. A known use of such an arrangement serves to avoid contamination by other influences, such as e.g. at a wheel hub or the like. Owing to the lubrication concentrated within the bearing, an accumulation of dust or particles of dirt is suppressed, which typically penetrates via a lubricating film extending outwards as far as the bearing seal. Moreover, a tendency for the oil to escape from the bearing is reduced by a capillary bond. A use of this property is also known from process-engineering applications in the food industry, wherein contamination of a product by a lubricating means of a bearing e.g. in a stirring device or the like is to be prevented. A further use which has become known resides in an application of vacuum pumps where a bearing lubrication can be subjected to a vacuum during pump operation.

EP 1 775 488 A1 describes, for the latter application, a rolling bearing cage having a moulded part consisting of porous synthetic resin for holding rolling elements, which is impregnated with a lubricating oil. In addition to the impregnation with the lubricating oil, a lubricating grease can also be applied in a periphery of the rolling elements, said grease filling a volume of 5 to at most 20% of the bearing in order to keep a leakage to the outside as low as possible.

An object of the invention is to provide a rolling bearing having an integrated sealing arrangement which is suitable as a compact bearing.

The object is achieved by a rolling bearing designed as a compact bearing having a sealing arrangement according to the features of claim 1.

The inventive rolling bearing having a sealing arrangement is characterised in particular in that a lubricant reservoir with a substrate that is porous in at least some sections is arranged circumferentially in a radial contact to a shaft section and an outer ring; wherein the lubricant reservoir, in pores of the substrate, includes a lubricant insoluble in water, and a volume of the lubricant reservoir and a volume of a lubricant filling with the lubricant take up a total volume of spaces between a wet-side shaft seal and a dry-side shaft seal.

The invention makes provision for the first time to use a lubricant reservoir consisting of partially solid and partially viscous structure not only to lubricate a rolling bearing but also to provide a durable sealing function against axial penetration of a medium through a rolling bearing by arranging the substrate saturated with lubricant in combination with filling with the same lubricant. The advantageous sealing function is explained hereinafter for the application of a shaft bearing in the operating environment of a water pump.

In its most general form, the invention is based upon the knowledge of using a lubricant reservoir in a rolling bearing which produces a locally bound viscous cushion with respect to a penetrating medium and in so doing differently directed effects contribute to a sealing function in the rolling bearing.

During the operation of a water pump, a pressure equilibrium is achieved between an increasing delivery pressure in the pump chamber and the lubricant reservoir in the rolling bearing, whilst any washing out of the water-insoluble lubricant from the pores of the substrate is prevented. In the event of an increasing outer pressure of the medium to be conveyed in the direction of the rolling-element rows, a sponge-like morphology of the lubricant reservoir ensures that any expansion of the lubricant reservoir in a radial direction component increases a separating effect with respect to a lubricant filling located downstream thereof. A displacement or compression of the lubricant reservoir produces in an axial direction component an increased contact pressure on the shaft seal to the dry side, wherein a lubricant filling downstream of the lubricant reservoir transfers the contact force to the corresponding sealing lip and lubricates it at the same time.

The inventive concept of the roller bearing having the sealing arrangement provides several advantages in a water pump.

The porous structure of the substrate and a water-insolubility of the lubricant effect local binding of the lubricant. Any washing-out of the rolling bearing by the ingress of a medium to be conveyed during the pressure equalisation during operation is prevented and low friction and low wear of the rolling elements and raceways are ensured.

The two opposite shaft seals are supplied with the lubricant and so the corresponding sealing lips slide on the shaft by means of a lubricating film. The shaft seals lubricated with lubricant achieve a considerably longer service life in comparison with coolant-lubricated shaft seals.

The sealing arrangement takes up a small amount of installation space within the structure of the rolling bearing and at the same time provides lubrication for the duration of the service life. Consequently, the rolling bearing having the sealing arrangement is suitable for use as a compact bearing, i.e. as a single unit for the bearing and sealing of a pump shaft.

The cooperation of the lubricant filling and the substrate of the lubricant reservoir, which is saturated with lubricant, and the shaft seals improves a sealing effect against axial penetration of the rolling bearing. Therefore, the rolling bearing having the sealing arrangement is suitable for applications with moisture-sensitive assemblies, such as in particular an electric motor of the dry-runner type or electronics. By reason of a smaller air gap between the rotor and stator, dry runners have a higher level of efficiency than a wet-runner electric motor. In comparison, dry runners are also more cost-effective because they can be purchased as a separate unit having standardised components, i.e. independently of a type-specific geometry of a pump.

In comparison with designs having a leakage container, in spite of a reliable seal a design of the housing can be simplified, an installation space and material costs can be saved and more compact overall dimensions can be achieved. Moreover, labyrinth seals or similarly structured seals can be replaced by more favourable shaft seals having a comparatively simply configured sealing lip.

Advantageous developments of the inventive rolling bearing having a sealing arrangement are the subject matter of the dependent claims.

According to one aspect of the invention, the porous substrate of the lubricant reservoir can be arranged between the wet-side shaft seal and a rolling-element row and be in contact with the wet-side shaft seal. Therefore, the shaft seal to the wet side is not exclusively supplied by the lubricant filling but is also in contact with the saturated substrate of the lubricant reservoir. A lubricating film formation which is more constant or more insensitive to pressure fluctuations can be ensured on a dynamic sealing surface of the corresponding sealing lip and the formation of deposits by coolant residues is suppressed more effectively. In particular, the sealing function of the sponge-like morphology of the lubricant reservoir is produced directly downstream of the shaft seal on the wet side. As a result, a potentially penetrating volume of the medium opposite the separated lubricant filling is kept as small as possible.

According to one aspect of the invention, the porous substrate of the lubricant reservoir can be arranged between the wet-side shaft seal and a rolling-element row, as well as between the rolling-element rows, and be in contact with the wet-side shaft seal. By expanding the lubricant reservoir compared with the lubricant filling, a volume proportion contributing to the sealing function owing to the sponge-like morphology and an axial sealing path contributing to media separation are increased.

According to one aspect of the invention, the porous substrate of the lubricant reservoir can be arranged between the wet-side shaft seal and a rolling-element row, between the rolling-element rows, as well as between a rolling-element row and the dry-side shaft seal, and be in contact with both the wet-side shaft seal as well as the dry-side shaft seal. By expanding the lubricant reservoir compared with the lubricant filling, the volume proportion contributing to the sealing function owing to the sponge-like morphology is increased again, and the axial sealing path contributing to media separation is maximised. Moreover, the shaft seal to the dry side is not exclusively supplied by the lubricant filling but is likewise in contact with the saturated substrate of the lubricant reservoir. As a result, again a lubricating film formation which is more constant or more insensitive to pressure fluctuations can be ensured on the corresponding sealing lip and a leakage of the lubricant to the dry side is suppressed more effectively.

According to one aspect of the invention, the porous substrate of the lubricant reservoir can extend through spaces of a rolling-element row and through spaces of the at least one rolling-element cage. By way of the additional expansion of the lubricant reservoir compared with the lubricant filling, the volume proportion contributing to the sealing function owing to the sponge-like morphology is maximised.

According to one aspect of the invention, the volume of the substrate can be entirely formed of a structure with open pores, and the open pores can be saturated with the lubricant. This optimises the sponge-like morphology of the lubricant reservoir.

According to one aspect of the invention, the substrate can be made of a polymer matrix with a defined porosity. By means of the polymer matrix, a porous substrate can be produced which provides optimised properties in relation to a suitable pore size and a suitable elasticity for the lubricant reservoir.

According to one aspect of the invention, the lubricant can be an oil. As a result, it is possible to provide an application-optimised viscosity of the lubricant filling in relation to the lubricating, sealing and leakage properties.

According to one aspect of the invention, a sealing lip of the dry-side shaft seal can be inclined towards a rolling bearing row. As a result, the sealing lip is pressed onto the shaft circumference.

According to one aspect of the invention, the dry-side shaft seal can be made of a fluororubber including vinylidene (di)fluoride. By selecting a fluororubber comprising vinylidene (di)fluoride or FKM for short, application-optimised properties of the friction and service life of a sealing lip on the shaft circumference on the dry side are achieved.

According to one aspect of the invention, the wet-side shaft seal can be made of polytetrafluorethylene. By selecting polytetrafluorethylene or PTFE for short, application-optimised properties of the friction and service life of a sealing lip on the shaft circumference on the wet side are achieved.

According to one aspect of the invention, a water pump for a coolant circuit in a vehicle is provided, wherein the rolling bearing having the sealing arrangement is arranged inside a pump housing between a pump chamber, in which a pump shaft is connected with a pump impeller, and a drive side of the pump housing, on which the pump shaft is driven. The use as a single compact bearing for a shaft in a pump which is optimised in relation to installation space constitutes a preferred product which is worthy of protection and comprises the rolling bearing having the sealing arrangement.

According to one aspect of the invention, a corresponding electric water pump is provided which comprises an electric motor of the dry-runner type which is connected to the pump shaft. This pump type constitutes a preferred product worthy of protection for using the sealing function of the rolling bearing having the sealing arrangement.

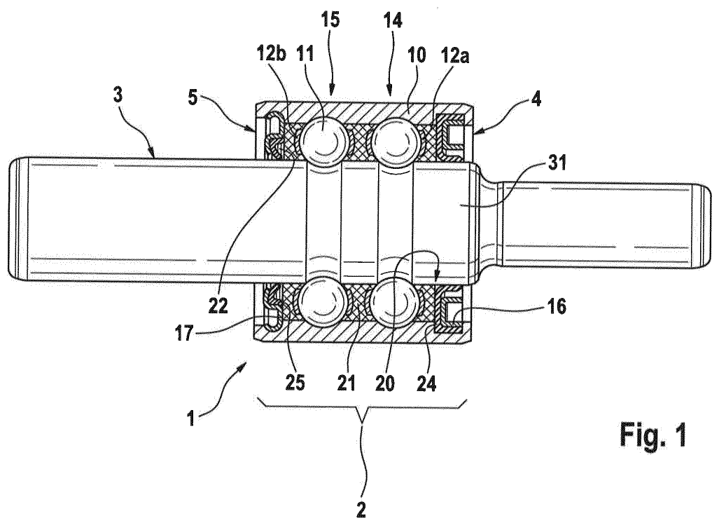

The invention will be described hereinafter with the aid of an exemplified embodiment with reference to FIG. 1.

FIG. 1 shows an optional longitudinal sectional view of the rolling bearing having the sealing arrangement according to one embodiment of the invention.

FIG. 1 shows a rolling bearing 1 in the form of a compact bearing which absorbs both radial forces and also axial forces of a shaft 3 and thus is suitable as a single unit for shaft bearing. A shaft 3 is mounted in the rolling bearing 1 and part of the shaft 3 located within an outer ring 10 of the rolling bearing 1 is referred to as shaft bearing section 31. In an inner peripheral surface of an outer ring 10, two axially adjacent and radially circumferential grooves having a round contour are formed as raceways for spherical rolling elements 11. On a shaft periphery of the shaft bearing section 31, two axially adjacent and radially circumferential grooves having a round contour are similarly formed opposite thereto as raceways for the spherical rolling elements 11. The rolling elements 11 are received in such a manner as to be able to roll in two rolling-element cages 12a, 12b and are held by the rolling-element cages 12a, 12b at equal distances in the circumferential direction of the raceways. The two formations of rolling elements 11 which are guided in the two raceways by means of the rolling-element cages 12, 12b constitute two rolling-element rows 14, 15. By way of the axial distance between the two rolling-element rows 14, 15 and by using the spherical rolling elements 11 in complementary grooves having a round contour, it is ensured that axial and radial forces are applied between the shaft 3 and the outer ring 10.

The sealed rolling bearing 1 is designed to seal the shaft 3 to be mounted between a wet side 4, which is in contact with a liquid medium, and a dry side 5, such as e.g. a cavity or an outer side, such that the liquid medium does not pass axially through the rolling bearing 1 even when there is a pressure difference between the two sides 4 and 5. For this purpose, the rolling bearing 1 is equipped with a sealing arrangement 2. The sealing arrangement 2 of the rolling bearing 1 comprises a wet-side shaft seal 24, a dry-side shaft seal 25 and a sealingly effective lubricant reservoir 20.

The wet-side shaft seal 24 is a radial shaft sealing ring having a dynamic sealing surface with respect to the shaft 3 and closes off a radial opening between the shaft bearing section 31 and the outer ring 10. The shaft seal 24 is held in the outer ring 1 in a step-like groove, which is recessed radially outwards, by means of a clamping ring 16. A sealing lip of the shaft seal 24 has a flange on the shaft circumference which faces outwards to the wet side 4. The shaft seal 24 with respect to the wet side 4 consists of PTFE. The dry-side shaft seal 25 is likewise a radial shaft sealing ring having a dynamic sealing surface with respect to the shaft 3 which closes off a radial opening between the shaft bearing section 31 and the outer ring 10. The shaft seal 24 is held in the outer ring 1 in a step-like groove, which is recessed radially outwards, by means of an annular support plate 17 and is acted upon at the inner side of the rolling bearing 1. Accordingly, a sealing lip of the shaft seal 25 is inclined inwards towards the rolling-bearing row 15, more precisely towards a section of the lubricant reservoir 20. A space between a radially outer part of the shaft seal 25 and the section of the lubricant reservoir 20 is taken up by a lubricant filling 22. The shaft seal 25 with respect to the dry side 5 consists of FKM.

In FIG. 1, the lubricant reservoir 20 is illustrated by checkered hatching. In the illustrated embodiment, the lubricant reservoir 20 takes up spaces between the shaft seals 24, 25 and the rolling-element rows 14, 15 in three sections of the rolling bearing 1. A section of the lubricant reservoir 20 which is the first section to come into contact with a potentially penetrating liquid medium is arranged in a space between the wet-side shaft seal 24 and the closest rolling-element row 14. This section of the lubricant reservoir 20 directed towards the wet side 24 constitutes, in contrast to the two downstream optional sections, an essential section and starting point in relation to the sealing function of the lubricant reservoir 20, as explained hereinafter.

In a delimiting definition with respect to a remaining volume of a lubricant filling 22, the lubricant reservoir 20 is composed of a volume of the porous substrate 21 as a basic structure for local binding of the lubricant, and of a volume of the lubricant which is bound in the porous substrate 21. The substrate 21 of the lubricant reservoir 20 is circumferentially in radial contact with the shaft 3 and the outer ring 10. In the present embodiment, the porous substrate 21 also extends between the sections of the lubricant reservoir 20 through spaces between the rolling-element rows 14, 15. The lubricant reservoir 20 has a sponge-like morphology. The sections of the lubricant reservoir 20 are in liquid communication with each other and with the lubricant filling 22. The lubricant filling 22 is a liquid cushion of the same lubricant which fills a remaining volume of the lubricant reservoir 20 in the rolling bearing 1 between the shaft seals 24 and 25. Part of the lubricant filling 22 in a space of the shaft seal 25 is illustrated in a cross-hatched manner in FIG. 1.

The lubricant reservoir 20 is one of the hybrid lubricants mentioned in the introductory part, the principle of which is defined as “solid oil”. The porous substrate 21 consists of an elastic flexible polymer matrix, preferably of a so-called Mikrozella having an open pore structure acting in a capillary manner. The lubricant which is absorbed in the pores of the substrate 21 of the lubricant reservoir 20 or is released in over-saturation and which also forms the lubricant filling 22 is a lubricating oil consisting of synthetic hydrocarbons, a silicone oil, an ester oil or the like, of which the viscosity is adjusted to a porosity of the substrate 21 and a loading of the rolling bearing 1.

The sealing function of the sealing arrangement 2 occurs when the lubricant reservoir 20 interacts with the shaft seals 24 and 25 under an externally acting pressure of a liquid medium on the wet side 4. As a consequence, a small leakage of the medium occurs under the sealing lip of the shaft seal 24 into the rolling bearing 1 until pressure equalisation is established. The rising pressure from a side of the lubricant reservoir 20 illustrated on the right effects axial compression and radial expansion of the porous substrate 21. Therefore, radial pressing of the sponge-like lubricant reservoir 20 against the shaft 3 and the outer ring 10 is increased. A water-insoluble property of the bound lubricant in the porous substrate 21 ensures media separation between the medium which has penetrated and the section of the rolling bearing 1 located downstream thereof such that any washing out of the lubricant filling 22 is prevented. Moreover, an axial contact pressure on the inwardly inclined sealing lip of the dry-side shaft seal 25 is increased by means of the lubricant filling 22. Since the sealing lip is lubricated by means of the lubricant, an increased surface pressure in relation to the frictional wear is non-critical.

An example of use, not illustrated, of a water pump in which the sealed rolling bearing 1 is used is described hereinafter.

In this case, a pump housing on the wet side 4 of the rolling bearing 1, illustrated on the right, comprises a pump chamber in which a pump impeller is driven by the shaft 3. In a typical design of such a water pump, a medium to be conveyed flows towards the pump impeller through an intake connection, is accelerated by blades of the pump impeller radially outwards into a spiral housing of the pump chamber and is diverted by the pressure connection. The wet-side shaft seal 24 is thus arranged downstream of the pump impeller at a passage of the shaft 3 to the pump chamber. Fixing of the rolling bearing 1 in a housing section delimiting the pump chamber downstream of the pump impeller can be provided by means of a press-fit of the outer ring 10 in a bearing seat.

A drive side of the pump housing is located on the dry side 5 illustrated on the left. The drive side can be formed as a receiving chamber of an electric motor which drives the shaft 3. The dry-side shaft seal 25 is thus arranged at a passage of the shaft 3 to the receiving chamber. Therefore, a compact design of a pump is produced having small axial dimensions, in which the rolling bearing 1 is arranged as a single shaft bearing unit in the housing. The electric motor is reliably sealed with respect to the medium to be conveyed in the pump chamber by the integrated sealing arrangement 2 of the rolling bearing 1

In embodiments which are not illustrated, the lubricant reservoir 20 can be arranged merely between the wet-side shaft seal 24 and the rolling-bearing row 14, or can extend as far as the next rolling-bearing row 15, whilst a remaining volume is taken up by the lubricant filling 22. The sealing function in accordance with the invention can also be achieved in these, or any other, ratios of volume proportions between the lubricant reservoir 20 and lubricant filling 22.

In alternative embodiments, not illustrated, the rolling-element rows have other shapes of the rolling elements. According to application-dependent loading or pump type, the two rolling-element rows can correspond to any combination of spherical rolling elements 11 and roller-like, roller-shaped or needle-shaped rolling elements 11 or the like. The rolling-element rows can be guided on a raceway in a combined arrangement in an axially parallel and perpendicular manner, or at an inclined angle to the shaft 3. For example, in the example of use of a displacement pump, in which higher tilting moments occur on the shaft, towards the wet side 4 a rolling-element row 14 having roller-shaped rolling elements can be used which absorbs higher axial forces. Furthermore, more than two rolling-bearing rows 14, 15 can be arranged in the rolling bearing 1 in an axially adjacent manner.

### LIST OF REFERENCE NUMERALS

1 Rolling bearing
2 Sealing arrangement
3 Shaft
4 Wet side
5 Dry side
10 Outer ring
11 Rolling element
12a Rolling-element cage
12b Rolling-element cage
14 Rolling-element row
15 Rolling-element row
16 Clamping ring
17 Support plate
20 Lubricant reservoir
21 Porous substrate
22 Lubricant filling
24 Wet-side shaft seal
25 Dry-side shaft seal
31 Shaft bearing section

1-13. (canceled)

14. A rolling bearing for water pumps, wherein the rolling bearing comprises a sealing arrangement and is configured for radial and axial mounting as well as sealing of a shaft of a water pump in a housing between a wet side, which is in contact with a liquid medium which flows through the water pump, and a dry side, which constitutes a drive side, the rolling bearing comprising:
an outer ring and a shaft bearing section at which raceways for at least two axially adjacent rolling-element rows are formed;
a plurality of rolling elements that are accommodated in at least one rolling-element cage and guided in the rolling-element rows;
the sealing arrangement having a wet-side shaft seal arranged between the wet side and a rolling-element row; and a dry-side shaft seal arranged between a rolling-element row and the dry side; and
a lubricant reservoir which is arranged circumferentially in a radial contact to the shaft section and the outer ring; wherein
the lubricant reservoir comprises a substrate that is porous in at least some sections which, in its pores, includes a lubricant insoluble in water, wherein a volume of the lubricant reservoir and a volume of a lubricant filling which is delimited with respect to the lubricant reservoir and is a liquid cushion filled with the same lubricant, take up a total volume of spaces between the wet-side shaft seal and the dry-side shaft seal,
a sealing function of the sealing arrangement is effected by an interaction of the lubricant reservoir with the shaft seals under an externally acting pressure of the liquid medium on the wet side.

15. The rolling bearing having the sealing arrangement according to claim 14, wherein the porous substrate of the lubricant reservoir is arranged between the wet-side shaft seal and a rolling-element row and is in contact with the wet-side shaft seal.

16. The rolling bearing having the sealing arrangement according to claim 14, wherein the porous substrate of the lubricant reservoir is arranged between the wet-side shaft seal and a rolling-element row, as well as between the rolling-element rows, and is in contact with the wet-side shaft seal.

17. The rolling bearing having the sealing arrangement according to claim 14, wherein the porous substrate of the lubricant reservoir is arranged between the wet-side shaft seal and a rolling-element row, between the rolling-element rows, as well as between a rolling-element row and the dry-side shaft seal, and is in contact with both the wet-side shaft seal as well as the dry-side shaft seal.

18. The rolling bearing having the sealing arrangement according to claim 14, wherein the porous substrate of the lubricant reservoir extends through spaces of a rolling-element row and through spaces of the at least one rolling-element cage.

19. The rolling bearing having the sealing arrangement according to claim 14, wherein the volume of the substrate is entirely formed of a structure with open pores, and the open pores are saturated with the lubricant.

20. The rolling bearing having the sealing arrangement according to claim 14, wherein the substrate is made of an elastically flexible polymer matrix with a defined porosity.

21. The rolling bearing having the sealing arrangement according to claim 14, wherein the lubricant is an oil.

22. The rolling bearing having the sealing arrangement according to claim 14, wherein a sealing lip of the dry-side shaft seal is inclined towards a rolling bearing row.

23. The rolling bearing having the sealing arrangement according to claim 14, wherein the dry-side shaft seal is made of a fluororubber including vinylidene (di)fluoride.

24. The rolling bearing having the sealing arrangement according to claim 14, wherein the wet-side shaft seal is made of polytetrafluorethylene.

25. A water pump for a coolant circuit in a vehicle, the water pump having a rolling bearing wherein the rolling bearing comprises a sealing arrangement and is configured for radial and axial mounting as well as sealing of a shaft of a water pump in a housing between a wet side, which is in contact with a liquid medium which flows through the water pump, and a dry side, which constitutes a drive side, the rolling bearing comprising:
an outer ring and a shaft bearing section at which raceways for at least two axially adjacent rolling-element rows are formed;
a plurality of rolling elements that are accommodated in at least one rolling-element cage and guided in the rolling-element rows;
the sealing arrangement having a wet-side shaft seal arranged between the wet side and a rolling-element row; and a dry-side shaft seal arranged between a rolling-element row and the dry side; and
a lubricant reservoir which is arranged circumferentially in a radial contact to the shaft section and the outer ring;
wherein the lubricant reservoir comprises a substrate that is porous in at least some sections which, in its pores, includes a lubricant insoluble in water, wherein a volume of the lubricant reservoir and a volume of a lubricant filling which is delimited with respect to the lubricant reservoir and is a liquid cushion filled with the same lubricant, take up a total volume of spaces between the wet-side shaft seal and the dry-side shaft seal,
a sealing function of the sealing arrangement is effected by an interaction of the lubricant reservoir with the shaft seals under an externally acting pressure of the liquid medium on the wet side; and
the rolling bearing having the sealing arrangement being arranged inside a pump housing between a pump chamber in which a pump shaft is connected with a pump impeller and a drive side of the pump housing on which the pump shaft is driven.

26. The water pump according to claim 25, further comprising an electric motor of a dry-runner type which is connected to the pump shaft.
